(19) United States
(12) Patent Application Publication
(10) Pub. No.: US 2009/0278808 A1
(43) Pub. Date: Nov. 12, 2009

(54) Method for controlling pointing device, pointing device and computer-readable storage medium

(75) Inventor: Katsuhiko Akiyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,659

(22) Filed: Jan. 30, 2009

(30) Foreign Application Priority Data
May 12, 2008 (JP) JP2008-124685

(51) Int. Cl. G06F 3/041

(52) U.S. Cl. 345/173

(57) ABSTRACT

An input mode is controlled in such a manner that a one-point input mode is set as an initial state, the one-point input mode is changed to a two-point input mode when both the first input point and the second input point are turned on and the two-point input mode is changed back to the one-point input mode when both the first input point and the second input point are turned off. A coordinate position of an indicated point is determined on the basis of an absolute position of the first input point in the one-point input mode and on the basis of a relative positional relationship between the first input point and the second input point in the two-point input mode.

### CROSS-REFERENCE TO RELATED APPLICATION

This application is based upon and claims the benefit of priority of the prior Japanese Patent Application No. 2008-124685, filed on May 12, 2008, the entire contents of which are incorporated herein by reference.

### FIELD

The embodiment discussed herein is related to a method for controlling a multi-touch type pointing device, a pointing device and a computer program. The embodiment is related to a technique to improve the operability of a pointing device. The technique described as the embodiment is applicable to, for example, a large tablet type pointing device, a large touch panel, a touch input-enabled large display device, other pointing devices and an apparatus including a pointing device.

### BACKGROUND

A touch panel (including a touch screen) having both a display function as a display device and a locator function (pointing function) on a display screen is conventionally frequently used. When a point on the display screen of the touch panel is pressed with a finger or a tip of a stylus by a user, the position of the point on the display screen can be specified for input.

Furthermore, a multi-touch type touch panel in which a plurality of positions (input points) can be simultaneously and independently sensed is used these days.

On the other hand, in a touch panel having a large size and a physically large input range like an electronic blackboard or a table-shaped touch panel, an operator sometimes should perform an operation beyond his/her reach. In such a case, the operator has to perform the operation while changing his/her own position.

Specifically, it is assumed, as illustrated in FIG. 20A, that an operator SS standing in front of the right end of a touch panel TP installed to have a display screen (input screen) HG vertically is giving explanation with reference to display on the display screen HG. At this point, when the operator SS wants to point at, for input, a button BTA displayed in a left end portion on the touch panel TP, the operator SS should walk to the left as illustrated in FIG. 20B. Additionally, since the button BTA is displayed in an upper portion, the operator SS should point at the button BTA with his/her hand reached out.

On the contrary, when a control method in which the absolute coordinate position pressed with a finger of an operator SS is regarded as an input point is employed in a compact touch panel, it is difficult to perform an operation with a portion smaller than a finger size pointed at.

These problems occur in employing an absolute coordinate input method in which a point on a display screen and an input position (indicated point) are in one-to-one correspondence on a touch panel. In order to avoid the problems, it is necessary to employ a scale-converted absolute coordinate input method in which a point on a display screen and an input position are corresponded to each other in different ratios, or to employ a relative coordinate input method.

In conventional techniques, the absolute coordinate input method, the relative coordinate input method and the scale-converted absolute coordinate input method are switched by any of the following methods:

A method (1) in which a precedently set input method is fixedly employed; a method (2) in which the aforementioned input methods are switched with a switching button; and a method (3) in which a window for inputting relative coordinates is opened (see Patent Document 1: Japanese Laid-Open Patent Publication No. 2004-310219).

In the above-described method (1), however, it takes time for the switching. In the method (2), the switching button is not always near the place where an operator SS is standing, and hence he/she should move for the switching, which is troublesome. Even if switching buttons are provided in a plurality of positions, it is also troublesome to reach for one of these switching buttons for the switching.

Also in the method (3) described above, a window for inputting relative coordinates is not always opened near the position where an operator SS is standing, and hence the operator SS should also move. Furthermore, even when a button for opening such a window near the operator SS would be provided, there arise problems similar to those occurring in employing the method (2).

### SUMMARY

In the method according to an embodiment of this invention for controlling a pointing device of a multi-touch type capable of sensing on/off states of a first input point and a second input point independently of each other, an input mode is controlled in such a manner that a one-point input mode is set as an initial state, that the one-point input mode is changed to a two-point input mode when both the first input point and the second input point are turned on and that the two-point input mode is changed back to the one-point input mode when both the first input point and the second input point are turned off. A coordinate position of an indicated point is determined on the basis of an absolute position of the first input point in the one-point input mode and on the basis of a relative positional relationship between the first input point and the second input point in the two-point input mode.

Since the switching between the one-point input mode and the two-point input mode is performed by turning on/off both the first input point and the second input point, an operator can easily switch the modes without changing his/her position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the schematic architecture of a touch panel system according to an embodiment of the invention;

FIG. 2 is a diagram roughly explaining a method for using the touch panel system;

FIG. 3 is a block diagram illustrating the architecture of a pointing control section employed in a single mode;

FIG. 4 is a timing chart explaining input mode control of the touch panel system;

FIG. 5 is a timing chart explaining a click input process;

FIG. 6 is a diagram illustrating an exemplified indicated point employed in a one-point input mode;

FIG. 7 is a diagram illustrating an exemplified indicated point employed in a two-point input mode;

FIG. 8 is a diagram illustrating an exemplified coordinate origin;

FIG. 9 is a diagram illustrating an exemplified indicated point employed in a change quantity mode;

FIG. 10 is a diagram illustrating an exemplified indicated point employed in a scale mode;

FIG. 11 is a diagram illustrating an exemplified indicated point employed in the scale mode;

FIG. 12 is a diagram illustrating another exemplified indicated point employed in the scale mode;

FIGS. 13A, 13B, 13C, 13D and 13E are diagrams illustrating exemplified kinds of cursors;

FIG. 14 is a flowchart illustrating the outline of control performed by the pointing control section;

FIG. 15 is a flowchart illustrating flow of a one-point input mode process;

FIG. 16 is a flowchart illustrating flow of a two-point input mode process;

FIG. 17 is a diagram roughly explaining a method for using the touch panel system employed in a group mode;

FIG. 18 is a block diagram illustrating another exemplified architecture of the pointing device employed in the group mode;

FIG. 19 is a flowchart illustrating flow of group management employed in the group mode; and

FIGS. 20A and 20B are diagrams illustrating a method for using a conventional touch panel system.

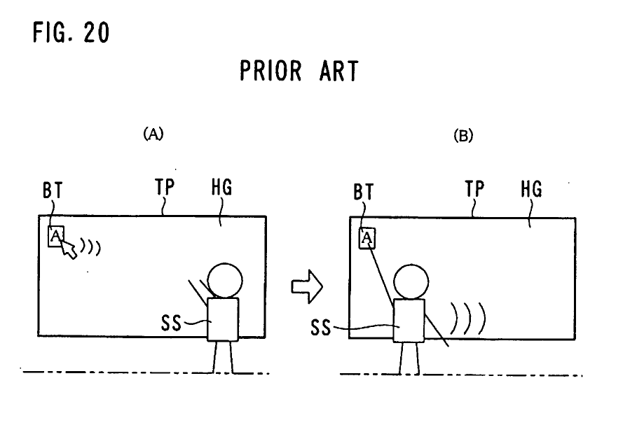

### DESCRIPTION OF EMBODIMENTS

Preferred embodiments of the present invention will be explained with reference to accompanying drawings.

### [General Description of Touch Panel System 1]

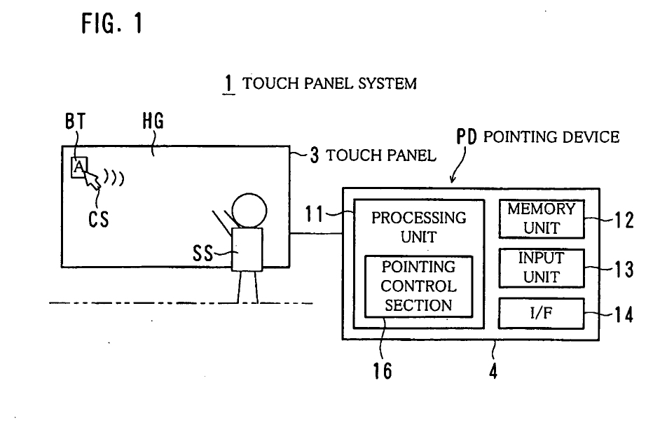

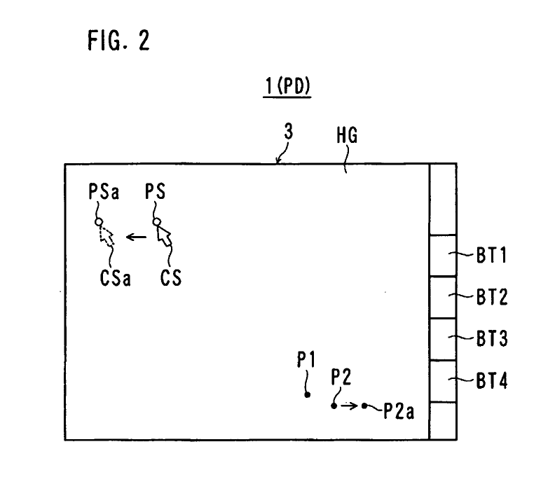

FIG. 1 is a diagram illustrating the rough architecture of a touch panel system 1 according to an embodiment of the invention, and FIG. 2 is a diagram roughly explaining a method for using the touch panel system 1.

In FIG. 1, the touch panel system 1 includes a touch panel 3 having a large rectangular display screen HG and a processor 4 that sends and receives signals and data to and from the touch panel 3.

The touch panel 3 displays an image output from the processor 4 on the display screen HG and outputs a signal corresponding to a position input on the display screen HG to the processor 4. The touch panel 3 is a multi-touch type touch panel (pointing device) capable of sensing on/off states of a plurality of input points (input positions) independently of one another. The touch panel 3 can employ any of various input point sensing methods including an electrical capacitance method, a resistance film method, a surface acoustic wave method and a matrix switch method.

Specifically, it is possible to employ, for example, a method in which a translucent display screen HG is irradiated with light from the back face thereof so as to catch, with a sensor, scattering of the light caused by something touching the front face of the display screen HG for sensing an input point P. Alternatively, a method using a liquid crystal display panel including an optical sensor may be employed.

The touch panel 3 of FIG. 1 is a large touch panel installed to have the display screen HG vertically, but may be a desk-shaped touch panel installed to have the display screen HG horizontally. Alternatively, it may be an intermediate touch panel used in a desk top form or a compact touch panel used in portable equipment.

The processor 4 is capable of externally receiving image data or other data, generating, processing and storing the data and outputting the data to the touch panel 3 or another device. The processor 4 includes a processing unit 11, a memory unit 12, an input unit 13, an interface unit 14 and the like. The processing unit 11 is provided with a pointing control section 16 for processing a signal corresponding to an input point on the display screen HG of the touch panel 3.

For example, while an operator SS is standing in front of the right end of the touch panel 3 for giving an explanation, the operator SS can input, by clicking, a button BTA displayed in an upper left portion through control of a cursor CS by specifying, for example, with both hands, two input points on the display screen HG without changing his/her position but with keeping the standing position as illustrated in FIG. 1.

A pointing device PD is configured or a pointing function PK is realized by a function for sensing an input point of the touch panel 3 and a control function of the pointing control section 16.

As illustrated in FIG. 2, the pointing device PD of the touch panel system 1 is of a multi-touch type capable of sensing on/off states of a first input point P1 and a second input point P2 independently of each other.

When the pointing device PD is turned on, the initial state is set to a one-point input mode MD1, and the input mode control is performed thereafter. In the input mode control, when both a first input point P1 and a second input point P2 are turned on, the one-point input mode MD1 is changed to a two-point input mode MD2, and when both the first input point P1 and the second input point P2 are turned off, the two-point input mode MD2 is changed back to the one-point input mode MD1. Accordingly, in accordance with the on/off states of the first input point P1 and the second input point P2, the one-point input mode MD1 and the two-point input mode MD2 are alternately switched.

In the one-point input mode MD1, the coordinate position of an indicated point PS is determined on the basis of the absolute position of a first input point P1, and in the two-point input mode MD2, the coordinate position of an indicated point PS is determined on the basis of the relative positional relationship between a first input point P1 and a second input point P2.

In determining the coordinate position of an indicated point PS, any of various determination methods can be selectively employed through operations with buttons BT1 through BT4, etc.

For example, in the two-point input mode MD2, the coordinate position of an indicated point PS is determined on the basis of an amount of change v per unit time (namely, a velocity) of a relative coordinate position between a first input point P1 and a second input point P2.

Specifically, the coordinate position of an indicated point PS is obtained as a function of the amount of change v. For example, the coordinate position of an indicated point PS is determined in accordance with a linear function of the amount of change v. Alternatively, the coordinate position of an indicated point PS is determined in accordance with a quadratic function of the amount of change v. The coordinate position of an indicated point PS can be determined in accordance with any of other various functions.

Alternatively, in the two-point input mode MD2, a value resulting from multiplication of a positional difference between a first input point P1 and a second input point P2 by a predetermined multiplying factor a is obtained as a coordinate value U, and a position corresponding to the coordinate value U in regard to a coordinate origin GT precedently set is determined as the coordinate position of an indicated point PS.

The coordinate origin GT can be determined by any of various methods.

For example, the first input point is set as the coordinate origin GT. In this case, an indicated point PS is on a line connecting the first input point P1 and the second input point P2. When the multiplying factor a is positive, an indicated point PS is on the side of the second input point P2 across the first input point P1, and when the multiplying factor a is negative, the indicated point PS is across the first input point P1 opposite to the second input point P2.

When the multiplying factor a is smaller than −1, namely, when a <−1, an indicated point PS is across the first input point P1 opposite to the second input point P2, and in addition, a distance therebetween is increased. As the absolute value of the multiplying factor a is larger, a position farther from the first input point P1 can be determined as an indicated point PS.

Alternatively, when the absolute value of the multiplying factor a is smaller than 1, namely, when −1<a<1, an indicated point PS is determined as a position with the distance between the first input point P1 and the second input point P2 reduced. As the absolute value of the multiplying factor a is smaller, the position of an indicated point PS can be more finely controlled.

The position of the coordinate origin GT on the display screen HG can be also variously set. For example, a corner of the display screen HG of the pointing device PD may be set as the coordinate origin GT. Alternatively, a center of the pointing device PD may be set as the coordinate origin GT.

Furthermore, in the two-point input mode MD2, when a first input point P1 is turned off and then turned on again with a second input point P2 kept in an on state, this is regarded and processed as a click input.

In the touch panel system 1, two or more input points P can be specified. In this case, a group mode MDG for grouping the input points P can be set. It is noted that the aforementioned control of merely two input points P1 and P2 is designated as a single mode MDS as opposed to this group mode MDG.

In the group mode MDG, the touch panel system 1 is controlled so that each of a plurality of operators SS can operate input points P belonging to each group.

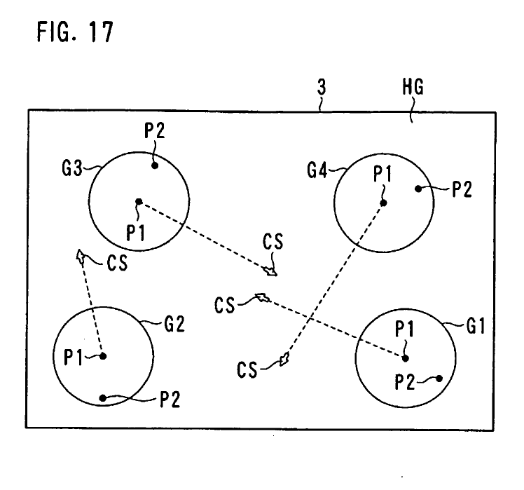

Specifically, for example, referring to FIG. 17, a plurality of input points P are grouped as follows: An input point P input first is set as a first input point P1 of a first group G1, an input point P that is turned on next in a predetermined range from the first input point P1 of the first group G1 is set as a second input point P2 of the first group G1, an input point P that is turned on next out of the predetermined range from the first input point P1 of the first group G1 is set as a first input point P1 of a second group G2, an input point P that is turned on next within the predetermined range from the first input point P1 of the second group G2 is set as a second input point P2 of the second group G2, and a similar process is repeated if necessary.

In each of the groups G1 through G4, control similar to that of the single mode MDS described above is performed.

Furthermore, in the group mode MDG, a cursor corresponding to the coordinate position of an indicated point PS determined in each group is displayed to be distinguishable from cursors CS of the other groups.

Moreover, the cursor CS of each group may include a pattern corresponding to the correlation with the first input point P1 of the group.

As the processor 4 for realizing such a pointing device PD, a personal computer can be used. In this case, the pointing control section 16 can be realized as software or as a function by allowing a CPU included in the personal computer to execute a program stored in a RAM or a ROM. Alternatively, the pointing control section 16 can be realized by a dedicated hardware circuit included in the personal computer or through combination of program execution and a hardware circuit.

Alternatively, the pointing device PD may be constructed by providing a CPU, a RAM, a ROM or another circuit device dedicated for realizing the pointing control section 16 to be combined with the touch panel 3 or to be included in the touch panel 3.

### [Single Mode MDS]

The pointing control section 16 will now be described in detail.

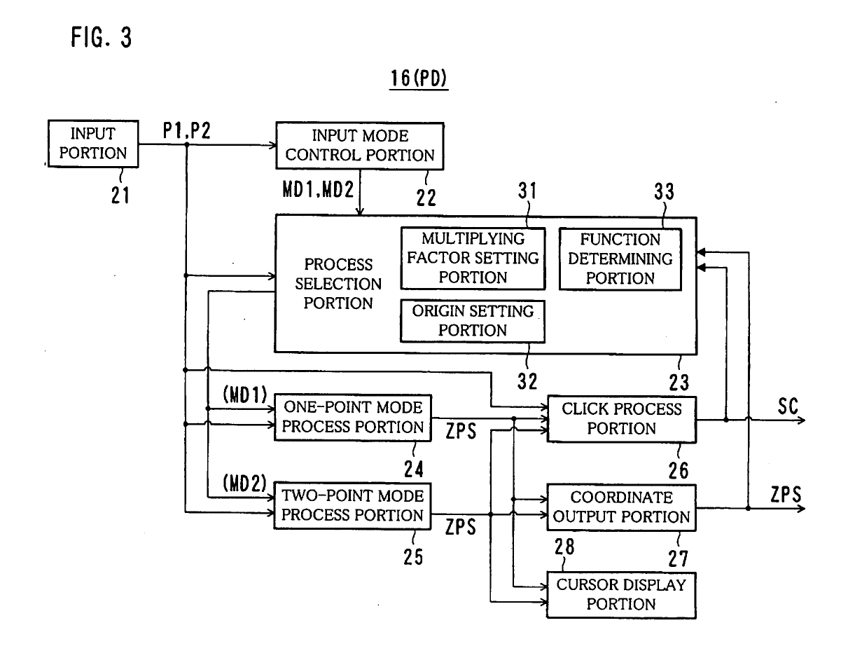

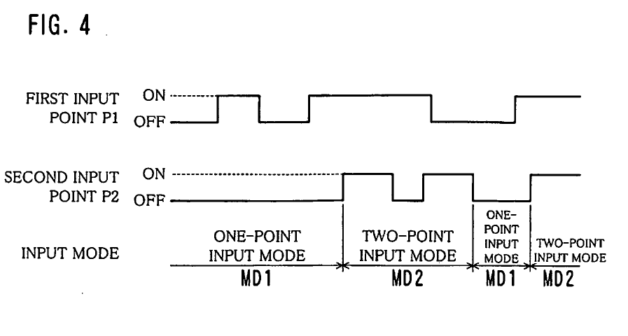

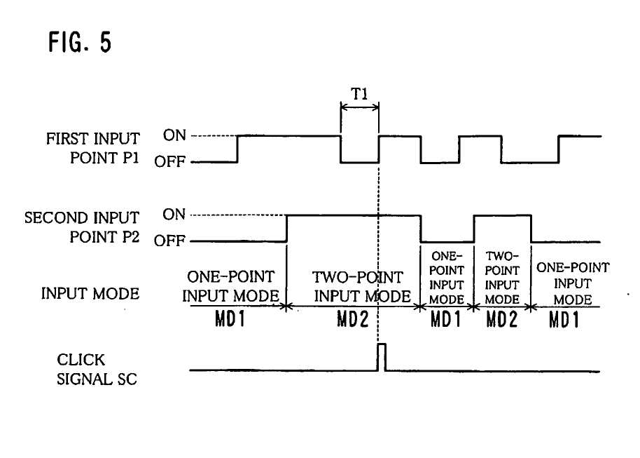

FIG. 3 is a block diagram illustrating an exemplified architecture of the pointing control section 16 employed in the single mode MDS, FIG. 4 is a timing chart explaining the input mode control of the touch panel system 1, and FIG. 5 is a timing chart explaining a click input process.

In FIG. 3, the pointing control section 16 includes an input portion 21, an input mode control portion 22, a process selection portion 23, a one-point mode process portion 24, a two-point mode process portion 25, a click process portion 26, a coordinate output portion 27, a cursor display portion 28 and the like.

The input portion 21 inputs an input point signal SP corresponding to a position input through the display screen HG of the touch panel 3. The input point signal SP is updated at predetermined time intervals. In other words, an input point P that is pressed with a finger or the like on the display screen HG of the touch panel 3 is newly sensed for update every scanning period TS for input sensing of the display screen HG of, for example, approximately 1 through 50 ms and preferably approximately 10 through 20 ms. When the input point P does not move, the same input point signal SP is output every scanning period TS. When the input point P moves by a distance B in one scanning period TS, the moving speed (an amount of movement) of the input point P, namely, the amount of change v, is expressed as v=B/TS.

The unit of the scanning period TS may be seconds or milliseconds, and the distance B may be in any of various units such as the number of pixels, a coordinate difference and an actual dimension.

Furthermore, with respect to the input point signal SP, a signal corresponding to a first input point P1 may be designated as a signal SP1 or P1, and a signal corresponding to a second input point P2 may be designated as a signal PS2 or P2. Also, the coordinates of a first input point P1 are expressed as (x1,y1) and the coordinates of a second input point P2 are expressed as (x2,y2). The amount of change v can be expressed as (vx, vy) by using an X-axis component vx and a Y-axis component vy. The coordinates of an indicated point PS are expressed as (X,Y).

Furthermore, third and subsequent input points P are ignored in the single mode MDS of this embodiment.

The input mode control portion 22 selects the one-point input mode MD1 or the two-point input mode MD2 as described above.

In FIG. 4, the one-point input mode MD1 is selected as the initial state, and an input point P input first is determined as a first input point P1. Accordingly, in the one-point input mode MD1, an indicated point PS can be moved by repeatedly turning on/off one input point P with its position changed or by changing the position of one input point P kept in an on state (namely, by dragging an input point P).

When a second input point P2 is turned on with the first input point P1 kept in an on state, the one-point input mode MD1 is changed to the two-point input mode MD2. In the two-point input mode MD2, even when one of the first input point P1 and the second input point P2 is turned off, the two-point input mode MD2 is retained. Accordingly, in the two-point input mode MD2, the first input point P1 and the second input point P2 can be moved to any positions with the two-point input mode MD2 retained by alternately turning them off to move their positions on the display screen HG from current positions to different positions.

The process selection portion 23 includes a multiplying factor setting portion 31, an origin setting portion 32 and a function determining portion 33. The process selection portion 23 selectively operates the one-point mode process portion 24 or the two-point mode process portion 25 in accordance with the input mode determined by the input mode control portion 22. Specifically, in the one-point input mode MD1, the one-point mode process portion 24 is operated, and in the two-point input mode MD2, the two-point mode process portion 25 is operated.

The one-point mode process portion 24 determines the coordinate position ZPS of an indicated point PS on the basis of the absolute position of a first input point P1 in the one-point input mode MD1.

Specifically, the one-point mode process portion 24 executes an absolute coordinate input process in which a point on the display screen HG of the touch panel 3 and a first input point P1 having been input are in one-to-one correspondence to each other. Accordingly, the coordinates (x1,y1) of the input point P1 are directly determined as the coordinate position ZPS of the indicated point PS.

The two-point mode process portion 25 determines the coordinate position ZPS of an indicated point PS on the basis of the relative positional relationship between a first input point P1 and a second input point P2 in the two-point input mode MD2. Specifically, the two-point mode process portion 25 executes a process in which a second input point P2 is regarded as a relative coordinate input.

The two-point mode process portion 25 determines the coordinate position of an indicated point PS on the basis of the amount of change v per unit time of a relative coordinate position between a first input point P1 and a second input point P2. In this case, merely the amount of change v of the second input point PS is used so that a current position of the indicated point PS can be updated in accordance with a function of the amount of change v.

Specifically, for example, the two-point mode process portion 25 determines the coordinate position of an indicated point PS in accordance with a linear function of the amount of change v. Alternatively, it determines the coordinate position of the indicated point PS in accordance with a quadratic function of the amount of change v.

A mode in which an indicated point PS is determined on the basis of the amount of change v is sometimes designated as a change quantity mode. Also, a mode in which an indicated point PS is determined in accordance with a linear function of the amount of change v is sometimes designated as a linear function mode, and a mode in which it is determined in accordance with a quadratic function of the amount of change v is sometimes designated as a quadratic function mode.

Alternatively, the two-point mode process portion 25 obtains, as a coordinate value U, a value resulting from multiplication of a positional difference between a first input point P1 and a second input point P2 by a predetermined multiplying factor a, and a position corresponding to the coordinate value U in regard to a coordinate origin GT precedently set is determined as the coordinate position of an indicated point PS. Such a mode is sometimes designated as a scale mode.

When an input point P is clicked for input (tapped for input), the click process portion 26 executes a click process on the input point P and outputs a click signal SC. Specifically, in the one-point input mode MD1, the click input of the first input point P1 is directly output as a click signal SC. The click process performed in the one-point input mode MD1 is equivalent to an absolute coordinate input operation performed in a general display integrated touch panel.

In the two-point input mode MD2, when a first input point P1 is turned off and turned on again with a second input point P2 kept in an on state, the click process portion 26 regards and processes this as a click input and outputs a click signal SC.

In the two-point input mode MD2, when a second input point P2 is turned on and turned off again within a predetermined period of time and the amount of movement of the second input point P2 is within a predetermined range, this may be regarded and processed as a click input.

In FIG. 5, when a first input point P1 is turned off and turned on again after time T1 in the two-point input mode MD2, a click signal SC is output. The time T1 is, for example, approximately 0.1 through 1 second. The time T1 can be set and changed by an operator SS.

The coordinate output portion 27 outputs a signal corresponding to the coordinate position ZPS of an indicated point PS.

The cursor display portion 28 executes a process for displaying, on the display screen HG, a cursor CS pointing the coordinate position of an indicated point PS. In displaying the cursor CS, the cursor display portion 28 displays cursors different in the shape, dimension, color or the like between the one-point input mode MD1 and the two-point input mode MD2 so that an operator SS can easily recognize a current mode as the one-point input mode MD1 or the two-point input mode MD2. Since a first input point P1 corresponds to the position of the cursor CS in the one-point input mode MD1, the cursor CS may not be displayed in this case.

An operator SS can select the kind of cursors CS, and the cursor display portion 28 displays the selected kind of cursors CS. Also, in the group mode MDG, a cursor CS pointing the coordinate position of an indicated point PS determined in each group is displayed to be distinguishable from cursors CS of other groups.

### [Detailed Description of Operation]

The operation will now be described in more details.

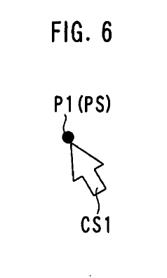

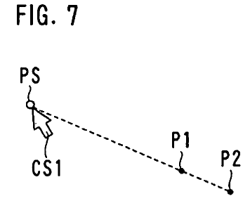

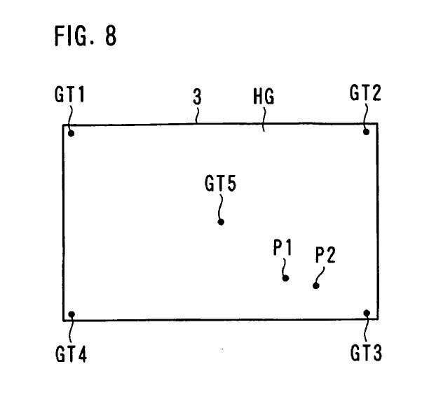

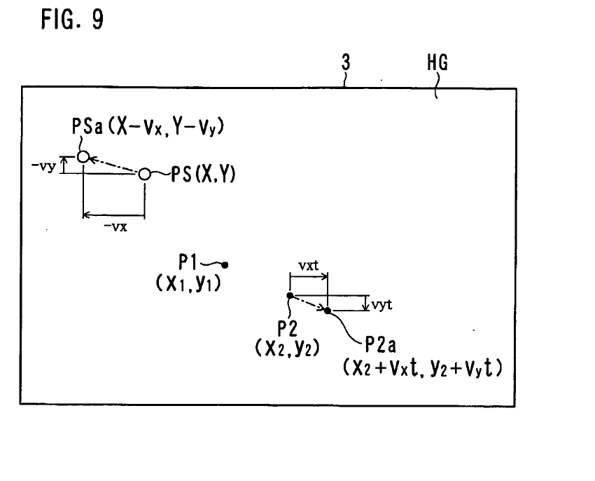

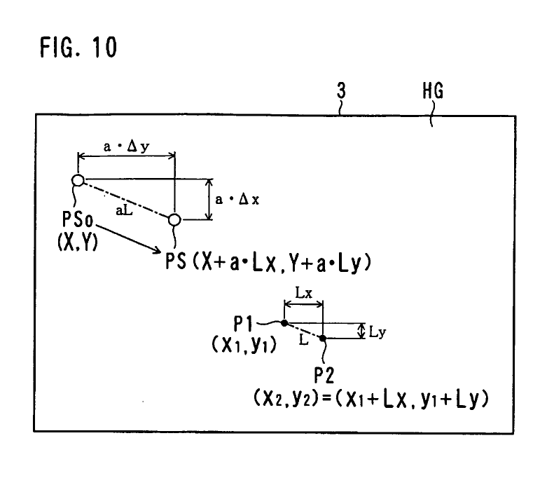

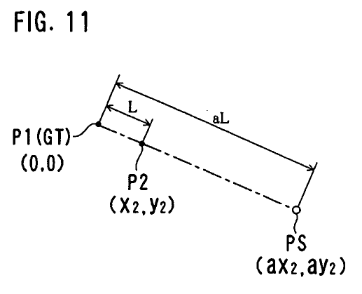

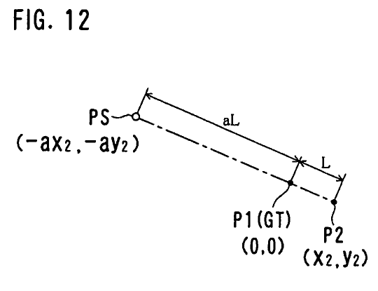

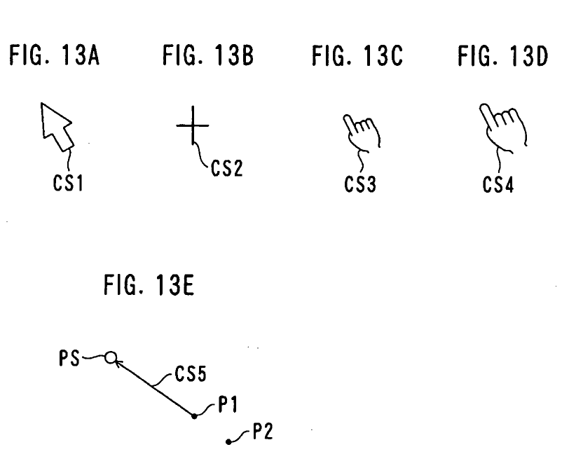

FIG. 6 is a diagram of an example of an indicated point PS employed in the one-point input mode MD1, FIG. 7 is a diagram of an example of an indicated point PS employed in the two-point input mode MD2, FIG. 8 is a diagram of examples of the coordinate origin GT, FIG. 9 is a diagram of an example of an indicated point PS employed in the change quantity mode, FIG. 10 is a diagram of an example of an indicated point PS employed in the scale mode, FIG. 11 is a diagram of an example of an indicated point PS employed in the scale mode, FIG. 12 is a diagram of another example of an indicated point PS employed in the scale mode, and FIGS. 13A through 13E are diagrams of exemplified kinds of a cursor CS.

In FIG. 6, in the one-point input mode MD1, a first input point P1 is specified to be set as an indicated point PS, and a cursor CS1 for pointing the indicated point PS is displayed.

In FIG. 7, in the two-point input mode MD2, a first input point P1 and a second input point P2 are specified, an indicated point PS is determined on the basis of the relative positional relationship between the first input point P1 and the second input point P2, and a cursor for pointing the indicated point PS is displayed.

In FIG. 8, upper left, upper right, lower right and lower left corners of the display screen HG of the touch panel 3 are respectively set as coordinate origins GT1, GT2, GT3 and GT4, and a center of the display screen HG is set as a coordinate origin GT5. It can be selectively determined by using, for example, the buttons BT1 through BT4 illustrated in FIG. 2, which of the coordinate origins GT1 through GT5 is to be used.

In FIG. 9, in the two-point input mode MD2, a first input point P1 and a second input point P2 are specified, so as to determine an indicated point PS. Under this condition, it is assumed that the second input point P2 is moved to a point P2a. The indicated point PS is moved to a new indicated point PSa in accordance with the moving speed of this movement, namely, in accordance with an amount of change v or the amplitude of coordinates (vx, vy).

The second input point P2 and the point P2a obtained after time t are illustrated in FIG. 9. Assuming that the time t is equivalent to the scanning period TS described above, a distance vt between the second input point P2 and the point P2a corresponds to the amount of change v per scanning period.

At this point, when the amount of change along the horizontal direction of the second input point P2 is indicated by vx and the amount of change thereof along the vertical direction is indicated by vy, the coordinates (X,Y) of an indicated point PS are expressed by the following expressions (1):

X←X+fx (vx,vy)

Y←Y+fy (vx,vy) Expressions (1):

The functions fx and fy are not particularly specified in this embodiment, and effective examples are a linear function and a quadratic function.

When the linear function is employed (i.e., in the linear function mode), the functions are expressed, for example, by the following expressions (2):

fx(x,y)=(aL+b)x

fy(x,y)=(aL+b)y Expressions (2):

wherein a and b are constants.

When the quadratic function is employed (i.e., in the quadratic function mode), the functions are expressed, for example, by the following expressions (3):

fx(x,y)=(aL2+bL+c)x

fy(x,y)=(aL2+bL+c)y Expressions (3):

wherein a, b, and c are constants.

When these functions are employed, as the moving speed of the second input point P2 is higher, the moving acceleration of the indicated point PS is higher.

In the example illustrated in FIG. 9, the amount of movement of the indicated point PS is determined in inverse proportion to the amount of change v. In other words, the new indicated point PSa is in a position moved in an inverse direction correspondingly to the amount of change v from the initial indicated point PS.

Accordingly, in this case, if the second input point P2 is moved faster, the amount of movement of the indicated point PS is correspondingly larger. Therefore, when the second input point P2 is moved quickly, the indicated point PS can be moved largely with small displacement.

Alternatively, when the second input point P2 is slowly moved, the amount of movement of the indicated point PS is correspondingly small. Therefore, when the second input point P2 is slowly moved, the indicated point PS can be finely and accurately moved.

Next, the scale mode will be described.

In FIG. 10, when an indicated point is in a position PS0 in the two-point input mode MD2, a first input point P1 and a second input point P2 are specified, and hence, the indicated point is moved to a position PS.

In FIG. 10, the amount of movement of the indicated point PS is determined as follows: A vector obtained by multiplying a vector extending from the first input point P1 to the second input point P2 by a predetermined multiplying factor a is applied to the initial indicated point PS0, and the thus obtained vector has a tip in a position corresponding to the moved indicated point PS.

More specifically, when a distance between the first input point P1 and the second input point P2 is indicated by L, a horizontal distance therebetween is indicated by Lx and a vertical distance therebetween is indicated by Ly, and the coordinates of the initial indicated point PS0 are (X,Y), the coordinates of the indicated point PS are expressed by the following expressions (4):

X←X+a(x2−x1)=X+a·Lx

Y←Y+a(y2−y1)=Y+a·Ly Expressions (4):

wherein a is a constant.

In this manner, in the scale mode, the indicated point PS0 is moved by a distance obtained by multiplying the distance (difference) between the first input point P1 and the second input point P2 by the multiplying factor a.

The initial indicated point PS0 may be selected from the coordinate origins GT, a point ultimately obtained in a precedent operation and the specified first input point P1.

In the scale mode, an indicated point PS is determined also on the basis of the relative positional relationship between a first input point P1 and a second input point P2, but after an initial indicated point PS0 is defined by specifying the first input point P1, the position of the indicated point PS is determined on the basis of the coordinate position of the second input point P2 obtained with the first input point P1 regarded as the origin. Therefore, in this sense, the process of the scale mode can be regarded to be executed as the absolute coordinate input process.

When the scale mode is employed, an arbitrary position on the display screen HG can be directly pointed in this manner. Accordingly, although it is difficult to finely control the operation, this mode is useful when it is necessary to quickly point at various positions on the display screen HG.

FIGS. 11 and 12 illustrate examples of an indicated point PS obtained with a first input point P1 regarded as the coordinate origin GT.

In FIG. 11, when a first input point P1 is specified, its position is set as the coordinate origin GT, and when a second input point P2 is specified, a point disposed at a distance obtained by multiplying a distance L between the first and second input points P1 and P2 by a multiplying factor a along the same direction is determined as an indicated point PS. This method is suitable when the indicated point PS is largely moved.

In this case, assuming that the first input point P1 is the coordinate origin GT (0,0), the coordinates (X,Y) of the indicated point PS are expressed by the following expressions (5):

X←a·x2

Y←a·y2 Expressions (5):

wherein a is a constant.

In FIG. 12, when a first input point P1 is specified, its position is set as the coordinate origin GT, and when a second input point P2 is specified, a point disposed at a distance obtained by multiplying a distance L between the first and second input points P1 and P2 by a multiplying factor a along the opposite direction is determined as the indicated point PS. This method is also suitable when the indicated point PS is largely moved.

In this case, assuming that the first input point P1 is the coordinate origin GT (0,0), the coordinates (X,Y) of the indicated point PS are expressed by the following expressions (6):

X←−a·x2

Y←−a·y2 Expressions (6):

wherein a is a constant.

As illustrated in FIGS. 13A through 13E, any of an arrow-shaped cursor CS1, a cross-shaped cursor CS2, a forefinger-shaped cursor CS3, a large forefinger-shaped cursor CS4 and a cursor CS5 including a line, that is, a pattern corresponding to correlation with a first input point P1, may be used as the cursor CS.

### [Description Referring to Flowcharts]

Next, the operation will be described with reference to the accompanying flowcharts.

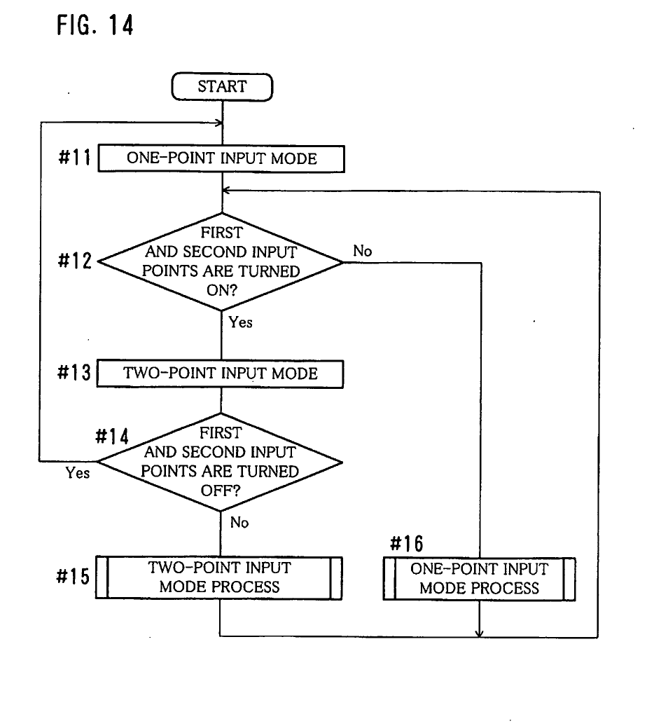

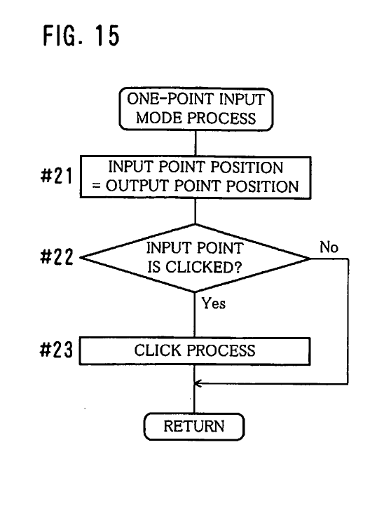

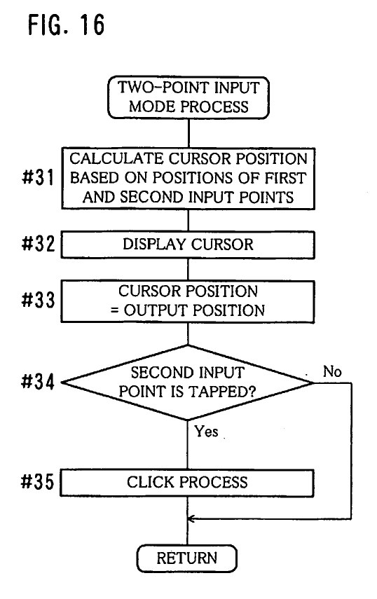

FIG. 14 is a flowchart illustrating the outline of the control performed by the pointing control section 16, FIG. 15 is a flowchart illustrating flow of the one-point input mode process, and FIG. 16 is a flowchart illustrating flow of the two-point input mode process.

In FIG. 14, the one-point input mode MD1 is set as the initial state (#11). When a first input point P1 and a second input point P2 are both turned on (namely, Yes in #12), the two-point input mode MD2 is set (#13). When both the first input point P1 and the second input point P2 are turned off (namely, Yes in #14), the one-point input mode MD1 is set (#11). The one-point input mode process is performed in the one-point input mode MD1 (#16), and the two-point input mode process is performed in the two-point input mode MD2 (#15).

In FIG. 15, in the one-point input mode process, the position of an input point P (a first input point P1) is determined as the position of an indicated point PS (output point position) (#21). When the input point P is clicked (namely, Yes in #22), the click process is performed (#23).

In FIG. 16, in the two-point input mode process, the position of a cursor CS (the position of an indicated point PS) is calculated on the basis of a first input point P1 and a second input point P2 (#31). The cursor CS is displayed in the calculated position (#32). The position of the cursor CS is determined as the position of the indicated point PS (#33). When a second input point P2 is tapped (namely, Yes in #34), the click process is performed (#35).

### [Group Mode]

Next, the group mode MDG will be described.

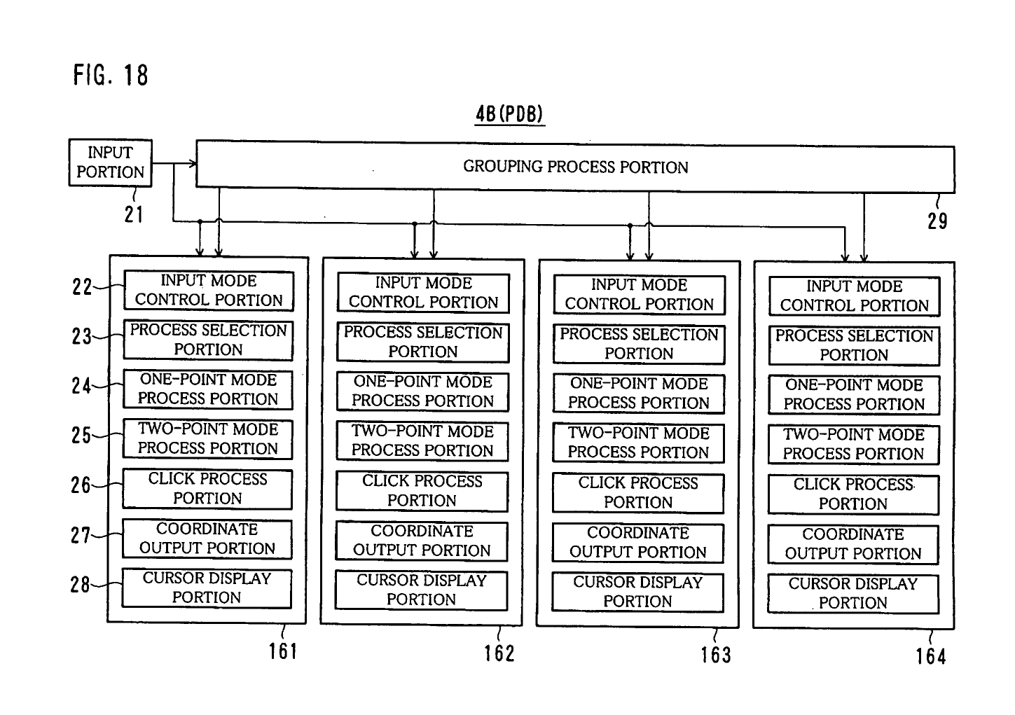

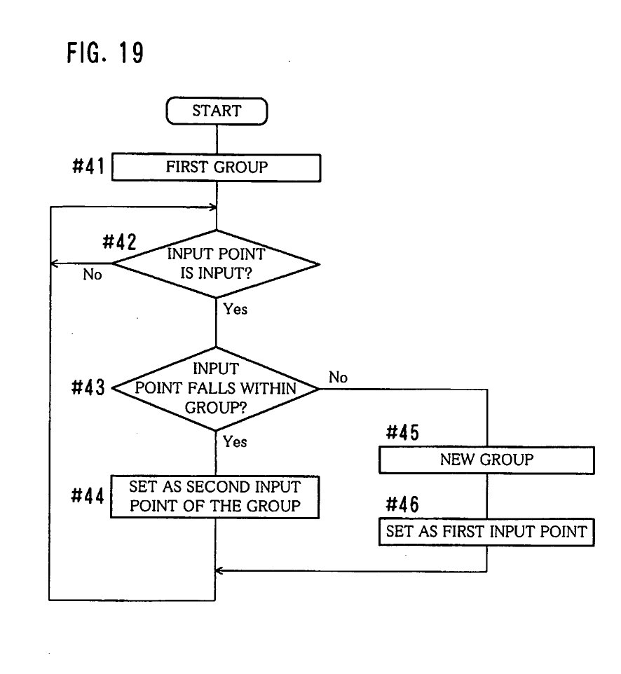

FIG. 17 is a diagram roughly explaining a method for using the touch panel system 1 employed in the group mode MDG, FIG. 18 is a block diagram illustrating an exemplified architecture of a pointing device PDB employed in the group mode MDG, and FIG. 19 is a flowchart illustrating flow of group management employed in the group mode MDG.

In FIG. 17, an input point P first specified is set as a first input point P1 of a first group G1 as described above. An input point P within a predetermined range from the first input point P1 is set as an input point P of the first group G1. The predetermined range corresponds to a circle with a radius r having the center on the first input point P1. This input point P input second is set as a second input point P2 of the first group G1. If the input point P input second does not fall within the predetermined range, the input point P is set as a first input point P1 of a new second group G2.

In the group mode MDG, the touch panel system 1 can be operated simultaneously by a plurality of operators SS, and the operators SS are preferably away from one another by a predetermined distance for performing the operation. However, ranges of two groups may sometimes overlap. In this case, when an input point P falls in the overlap range, the input point P is determined to belong to a group whose first input point P1 is closer.

The position of each group is moved by moving the first input point P1 of that group. The radius r for defining the predetermined range or the definition of the predetermined range itself can be variously selected through the operation with, for example, the buttons BT1 through BT4.

It is noted that a third input point P3 and subsequent input points are not set because merely two input points P belong to each group in this embodiment. However, the touch panel system can be controlled by a method in which the third and subsequent input points are used.

In FIG. 18, a pointing device PDB provided in a processor 4B includes an input portion 21, a grouping process portion 29 and four pointing control sections 161 through 164.

The input portion 21 inputs an input point signal SP corresponding to a position input through the display screen HG of the touch panel 3.

The grouping process portion 29 performs and manages grouping of input points P in accordance with input orders and positions of input point signals SP as described above.

Specifically, when a new input point P is input, it is checked whether or not the input point P falls within a range of a predetermined distance from a first input point P1, that is, a representative point of each group. A group represented by a first input point P1 disposed at the predetermined distance from and closest to the input point P is determined as a group to which the input point P is to belong, and the input point P is added to the group. If the input point P does not fall in a range of any group, a new group having the input point P as a first input point P1 is generated and the input point P is incorporated into the new group.

As a representative point of a group, not only a first input point P1 but also, for example, a coordinate position obtained as an average of coordinates of input points P belonging to the group may be used.

Each of the pointing control sections 161 through 164 includes, in the same manner as the aforementioned pointing control section 16, an input mode control portion 22, a process selection portion 23, a one-point mode process portion 24, a two-point mode process portion 25, a click process portion 26, a coordinate output portion 27 and a cursor display portion 28. Each of the pointing control sections 161 through 164 performs the same control operation as the aforementioned pointing control section 16 independently of one another.

In FIG. 19, when an input point P is first input, a first group G1 including it as a first input point P1 is generated (#41). When a next input point P is input (namely, Yes in #42), if the input point P falls within the group (namely, Yes in #43), it is included in the group as a second input point P2 (#44). If the input point P is out of the group, a new group is generated (#45), and the input point P is set as a first input point P1 of the new group (#46).

The application in the group mode MDG as illustrated in FIG. 17 is suitable when, for example, the touch panel 3 is installed to have the display screen HG horizontally so that a plurality of operators SS surrounding the display screen HG can operate the touch panel system while seeing the display screen HG. Specifically, when the touch panel 3 is installed on a table provided in a meeting room or an exhibition room, a plurality of operators SS can join to have a meeting or to give or receive an explanation while seeing the display screen HG even in seated positions.

According to this embodiment, the absolute coordinate input and the relative coordinate input can be switched through the operation of input points P performed by each operator SS without changing his/her position, and hence, the operability can be improved.

In particular, an operator SS can easily switch the input mode temporarily to the relative coordinate input (namely, the two-point input mode MD2) by simultaneously inputting two input points P from any position in the vicinity of the touch panel 3. Accordingly, regardless of the standing position or the position of the seat of the operator SS, he/she can perform the switching between the relative coordinate input and the absolute coordinate input (i.e., the one-point input mode MD1), and can easily perform an operation on a position on the display screen HG away from him/her without forgetting to change the relative coordinate input back to the absolute coordinate input.

In the aforementioned embodiment, when both a first input point P1 and a second input point P2 are turned off, the input mode returns to the one-point input mode MD1, and at this point, an indicated point PS keeps its position. Also, when a first input point P1 is turned off in the two-point input mode MD2, an indicated point PS keeps its position.

In the aforementioned embodiment, the architecture, the shape, the dimension, the number, the material of the whole of or each component of the pointing control section 16, the pointing device PD, the processor 4, the touch panel 3 or the touch panel system 1, the contents displayed on the screen, the contents and the orders of the processes, etc. can be appropriately modified in accordance with the scope of the invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method for controlling a pointing device of a multi-touch type capable of sensing on/off states of a first input point and a second input point independently of each other, comprising:
performing input mode control in such a manner that a one-point input mode is set as an initial state, the one-point input mode is changed to a two-point input mode when both the first input point and the second input point are turned on and the two-point input mode is changed back to the one-point input mode when both the first input point and the second input point are turned off; and
determining a coordinate position of an indicated point on the basis of an absolute position of the first input point in the one-point input mode and on the basis of a relative positional relationship between the first input point and the second input point in the two-point input mode.

2. The method for controlling a pointing device according to claim 1,
wherein the coordinate position of the indicated point is determined on the basis of an amount of change per unit time of a relative coordinate position between the first input point and the second input point in the two-point input mode.

3. The method for controlling a pointing device according to claim 2,
wherein the coordinate position of the indicated point is determined in accordance with a linear function of the amount of change.

4. The method for controlling a pointing device according to claim 2,
wherein the coordinate position of the indicated point is determined in accordance with a quadratic function of the amount of change.

5. The method for controlling a pointing device according to claim 1,
wherein a value resulting from multiplication of a positional difference between the first input point and the second input point by a predetermined multiplying factor is obtained as a coordinate value and a position corresponding to the coordinate value in regard to a coordinate origin precedently set is determined as the coordinate position of the indicated point in the two-point input mode.

6. The method for controlling a pointing device according to claim 5,
wherein the first input point is set as the coordinate origin.

7. The method for controlling a pointing device according to claim 6,
wherein the predetermined multiplying factor is smaller than −1.

8. The method for controlling a pointing device according to claim 5,
wherein a corner of the pointing device is set as the coordinate origin.

9. The method for controlling a pointing device according to claim 5,
wherein a center of the pointing device is set as the coordinate origin.

10. The method for controlling a pointing device according to claim 1,
wherein it is regarded and processed as a click input when the first input point is turned off and turned on again with the second input point kept in an on state in the two-point input mode.

11. A method for controlling a pointing device of a multi-touch type capable of sensing on/off states of a plurality of input points independently of one another, comprising:
grouping the plurality of input points by setting an input point turned on first as a first input point of a first group, setting an input point turned on next within a predetermined range from the first input point of the first group as a second input point of the first group, setting an input point turned on next out of the predetermined range from the first input point of the first group as a first input point of a second group, setting an input point turned on next within the predetermined range from the first input point of the second group as a second input point of the second group and repeating the settings if necessary;
performing, in each group, input mode control in such a manner that a one-point input mode is set as an initial state, the one-point input mode is changed to a two-point input mode when both the first input point and the second input point are turned on and the two-point input mode is changed back to the one-point input mode when both the first input point and the second input point are turned off; and
determining, in each group, a coordinate position of an indicated point on the basis of an absolute position of the first input point in the one-point input mode and on the basis of a relative positional relationship between the first input point and the second input point in the two-point input mode.

12. The method for controlling a pointing device according to claim 11,
wherein a cursor corresponding to the coordinate position of the indicated point determined in each group is displayed to be distinguishable from a cursor of another group.

13. The method for controlling a pointing device according to claim 12,
wherein a cursor of each group includes a pattern corresponding to correlation with the first input point of the corresponding group.

14. A pointing device of a multi-touch type capable of sensing on/off states of a first input point and a second input point independently of each other, comprising:
an input mode control portion that sets a one-point input mode as an initial state, changes the one-point input mode to a two-point input mode when both the first input point and the second input point are turned on and changes the two-point input mode back to the one-point input mode when both the first input point and the second input point are turned off;
a one-point mode process portion that determines a coordinate position of an indicated point on the basis of an absolute position of the first input point in the one-point input mode; and
a two-point mode process portion that determines the coordinate position of the indicated point on the basis of a relative positional relationship between the first input point and the second input point in the two-point input mode.

15. The pointing device according to claim 14,
wherein the two-point mode process portion determines the coordinate position of the indicated point on the basis of an amount of change per unit time of a relative coordinate position between the first input point and the second input point.

16. The pointing device according to claim 14,
wherein the two-point mode process portion obtains, as a coordinate value, a value-resulting from multiplication of a positional difference between the first input point and the second input point by a predetermined multiplying factor and determines, as the coordinate position of the indicated point, a position corresponding to the coordinate value in regard to a coordinate origin precedently set.

17. The pointing device according to claim 14, further comprising a click input process portion that performs a process by regarding and processing it as a click input when the first input point is turned off and turned on again with the second input point kept in an on state in the two-point input mode.

18. A pointing device of a multi-touch type capable of sensing on/off states of a plurality of input points independently of one another, comprising:
a group process portion that groups the plurality of input points by setting an input point turned on first as a first input point of a first group, setting an input point turned on next within a predetermined range from the first input point of the first group as a second input point of the first group, setting an input point turned on next out of the predetermined range from the first input point of the first group as a first input point of a second group, setting an input point turned on next within the predetermined range from the first input point of the second group as a second input point of the second group and repeating the settings if necessary;
an input mode control portion, provided with respect to each group obtained by the group process portion, that sets a one-point input mode as an initial state, changes the one-point input mode to a two-point input mode when both the first input point and the second input point are turned on and changes the two-point input mode back to the one-point input mode when both the first input point and the second input point are turned off;
a one-point mode process portion, provided with respect to each group obtained by the group process portion, that determines a coordinate position of an indicated point on the basis of an absolute position of the first input point in the one-point input mode; and
a two-point mode process portion, provided with respect to each group obtained by the group process portion, that determines the coordinate position of the indicated point on the basis of a relative positional relationship between the first input point and the second input point in the two-point input mode.

19. The pointing device according to claim 18, further comprising a cursor display portion that displays a cursor corresponding to the coordinate position of the indicated point determined in each group to be distinguishable from a cursor of another group.

20. A computer-readable storage medium storing a program for a pointing device of a multi-touch type capable of sensing on/off states of a first input point and a second input point independently of each other, the program allowing a computer to execute:
an input mode control process setting a one-point input mode as an initial state, changing the one-point input mode to a two-point input mode when both the first input point and the second input point are turned on and changing the two-point input mode back to the one-point input mode when both the first input point and the second input point are turned off;
a process determining a coordinate position of an indicated point on the basis of an absolute position of the first input point in the one-point input mode; and
a process determining the coordinate position of the indicated point on the basis of a relative positional relationship between the first input point and the second input point in the two-point input mode.
